(19) United States
(12) Patent Application Publication
(10) Pub. No.: US 2016/0223135 A1
(43) Pub. Date: Aug. 4, 2016

(54) SUPPORT FRAME DEVICE

(71) Applicant: APIX, Inc., Hsinchu City (TW)

(72) Inventors: Chuan-Kuei Tsai, Hsinchu City (TW); Shih-Chuan Lee, Hsinchu City (TW)

(73) Assignee: APIX, Inc., Hsinchu City (TW)

(21) Appl. No.: 15/008,953

(22) Filed: Jan. 28, 2016

(30) Foreign Application Priority Data
Feb. 3, 2015 (TW) 104201733

(51) Int. Cl. F16M 13/02; F21V 19/00

(52) U.S. Cl. CPC F16M 13/02; F21V 19/00

(57) ABSTRACT

A support frame device includes a stationary frame unit that is adapted for supporting two back plates thereon, and a plurality of magnetic units. Each of magnetic units includes a magnetic component connected fixedly to the stationary frame unit, and a magnetic ring. The magnetic ring is adapted to be connected fixedly to a corresponding one of the back plates, surrounds the magnetic component, and is magnetically repulsed from the magnetic component. The back plates are driven by the magnetic rings of the magnetic units to be orderly arranged.

### CROSS REFERENCE TO RELATED APPLICATION

This application claims priority of Taiwanese Patent Application No. 104201733, filed on Feb. 3, 2015.

### FIELD

The disclosure relates to a support frame device, more particularly to a support frame device adapted for supporting a plurality of back plates thereon.

### BACKGROUND

A number of connection devices for connecting boards or plates have been disclosed. For example, Taiwanese Utility Model Patent No. M447617 discloses a connection seat for connecting two light-emitting diode (LED) lamp boards, which includes two connection units that are mounted on the LED lamp boards, respectively. Each of the connection units has male and female connecting members. The LED lamp boards are connected with each other through a plug-socket engagement of the male and female connecting members of the connection units mounted thereon.

Furthermore, Taiwanese Utility Model Patent No. M494335 discloses an assembly of multiple display back plates, which includes two interengageable structures respectively formed on two adjacent display back plates to be connected. The two adjacent display back plates are connected by an engagement of the interengageable structures, followed by welding.

However, a gap may be formed between the boards or between the back plates due to dimensional tolerances of the boards or the back plates. When the boards or the back plates are mounted on a frame unit composed of a plurality of support frames, dimensional tolerances of the support frames may widen the gap between the boards or between the back plates, and adversely affect proper fitting between the boards or between the back plates.

### SUMMARY

Therefore, the object of the disclosure is to provide a support frame device that can alleviate the drawback of the conventional connection devices for boards or plates.

According to the disclosure, a support frame device includes a stationary frame unit that is adapted for supporting two back plates thereon, and a plurality of magnetic units. Each of the magnetic units includes a magnetic component connected fixedly to the stationary frame unit, and a magnetic ring. The magnetic ring is adapted to be connected fixedly to a corresponding one of the back plates, surrounds the magnetic component, and is magnetically repulsed from the magnetic component. As a result, the back plates are driven by the magnetic rings of the magnetic units to be orderly arranged.

### BRIEF DESCRIPTION OF THE DRAWINGS

Other features and advantages of the disclosure will become apparent in the following detailed description of the embodiment with reference to the accompanying drawings, of which:

FIG. 1 is a perspective view illustrating an embodiment of a support frame device according to the disclosure;

FIG. 2 is an exploded perspective view of the embodiment;

FIG. 3 is an exploded perspective view illustrating a structure of a magnetic unit of the embodiment;

FIG. 4 is a sectional view illustrating one magnetic pole arrangement of the magnetic unit of the embodiment;

FIG. 5 is a sectional view illustrating another magnetic pole arrangement of the magnetic unit of the embodiment;

FIG. 6 is a fragmentary schematic view of the embodiment; and

FIG. 7 is a sectional view of the embodiment.

### DETAILED DESCRIPTION

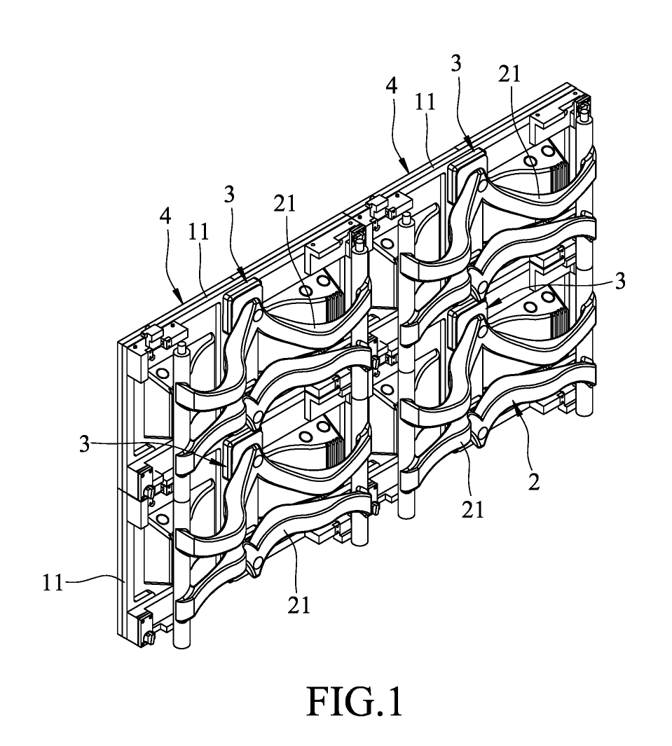

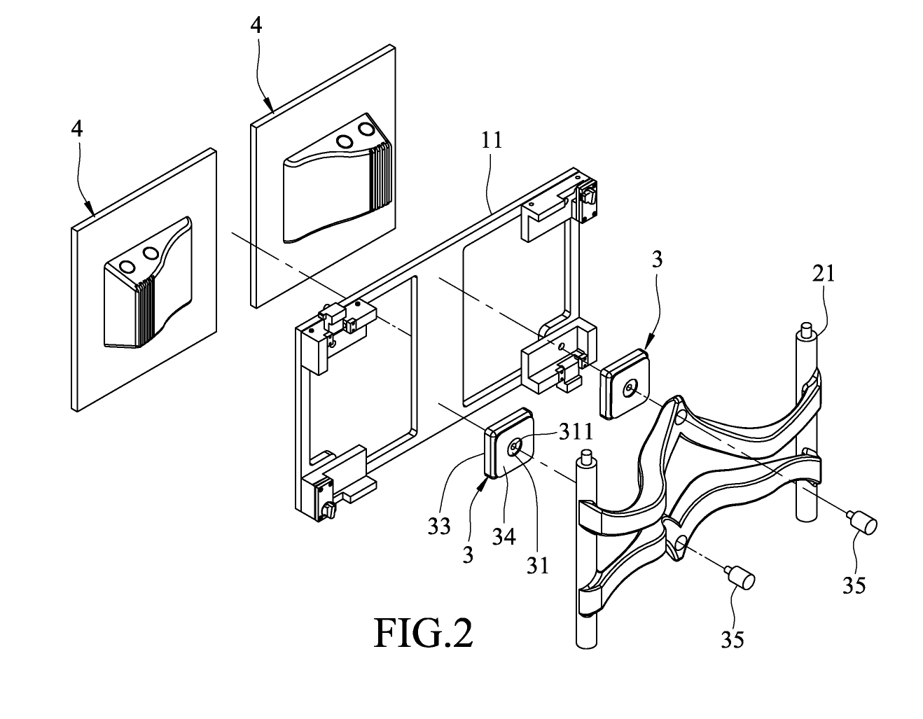

Referring to FIG. 1 to FIG. 3, an embodiment of a support frame device according to the disclosure is illustrated. The support frame device includes a stationary frame unit 2 that supports two back plates 11 thereon, and eight magnetic units 3 that interconnect the back plates 11 and the stationary frame unit 2.

In this embodiment, the number of the back plates 11 is exemplified to be four. The four back plates 11 are connected to each other and arranged in a two-by-two matrix. Connection between the back plates 11 may be a plug-socket or anchor-hole engagement, etc. The back plates 11 can be used for installing light sources, such as lamps 4, or displays (not shown).

The stationary frame unit 2 includes four frame members 21 that are connected in pairs so as to respectively support the four back plates 11.

Each of the magnetic units 3 includes a magnetic component 31 and a magnetic ring 32. The magnetic component 31 is connected fixedly to the stationary frame unit 2 and has s an extension hole 311. The magnetic ring 32 surrounds the magnetic component 31, and is magnetically repulsed from the magnetic component 31.

In this embodiment, each of the magnetic units 3 further includes a retaining seat 33, a lid 34 and a pin 35. The retaining seat 33 receives the magnetic component 31 and the magnetic ring 32 therein, is connected fixedly to a corresponding one of the back plates 11, and has an opening 331 opened toward a corresponding one of the frame members 21 of the stationary frame unit 2. The lid 34 covers the opening 331 and has a lid hole 341. The pin 35 sequentially extends fittingly through the corresponding one of the frame members 21, movably through the lid hole 341 and fittingly through the extension hole 311 for connecting fixedly the magnetic component 31 to the stationary frame unit 2. In this embodiment, the magnetic ring 32 is fitted in the retaining seat 33.

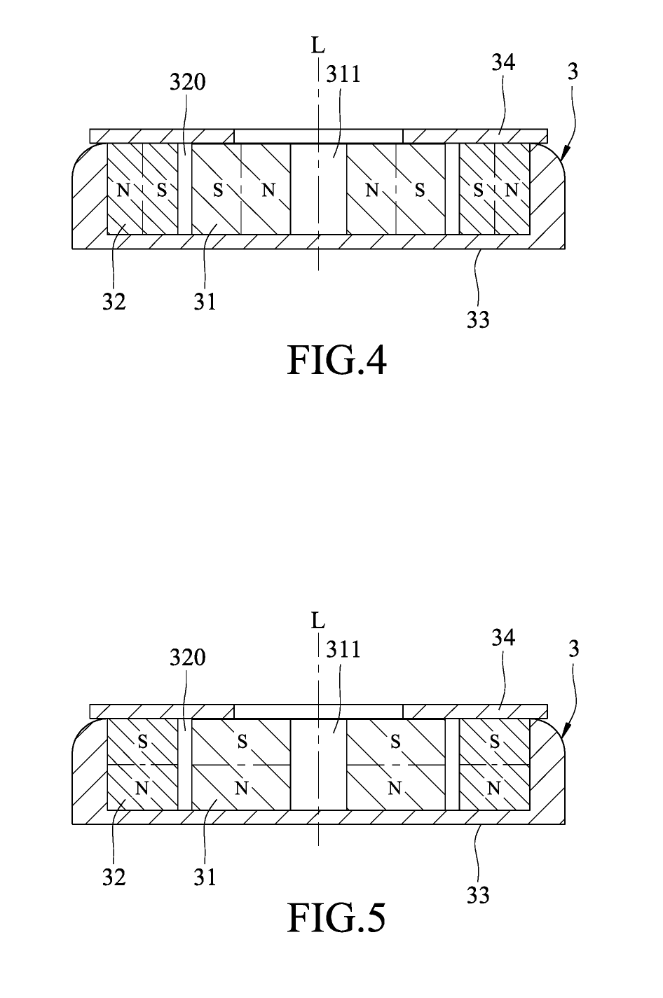

As shown in FIG. 4 and FIG. 5, the magnetic component 31 and the magnetic ring 32 of each of the magnetic units 3 cooperatively define a gap 320 therebetween. The gap 320 has a width ranging between 0.5 millimeters and 1.5 millimeters, and preferably, the gap 320 has a width of 1 millimeter.

Furthermore, the magnetic ring 32 of each of the magnetic units 3 has a central axis (L), and is magnetically repulsed from the respective magnetic component 31. To be more specific, opposite magnetic poles of each of the magnetic component 31 and the magnetic ring 32 of each of the magnetic units 3 can be arranged in a radial direction of the magnetic ring 32, as shown in FIG. 4, or in an axial direction parallel to the central axis (L), as shown in FIG. 5.

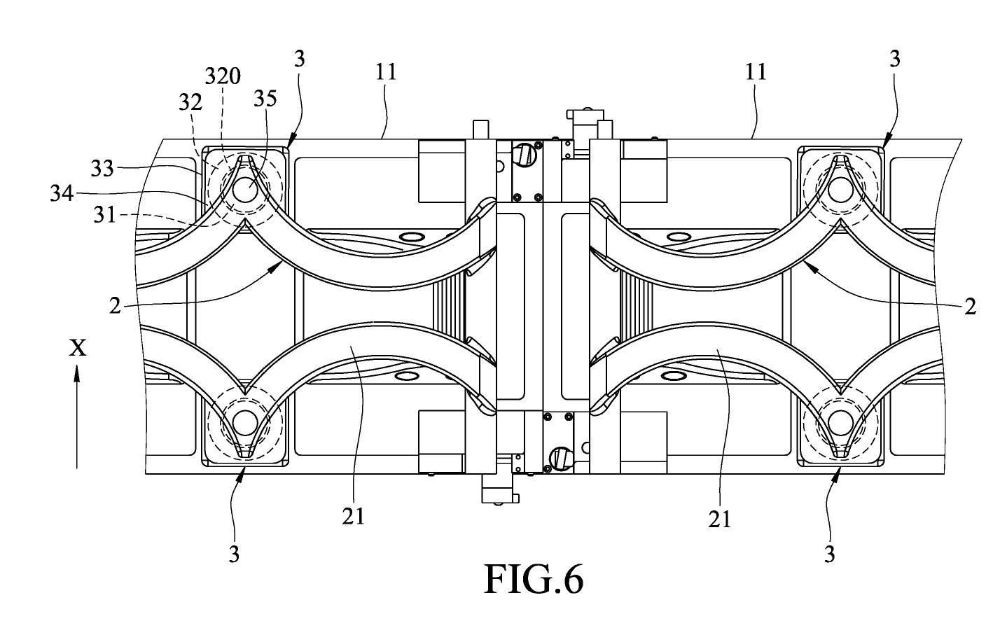

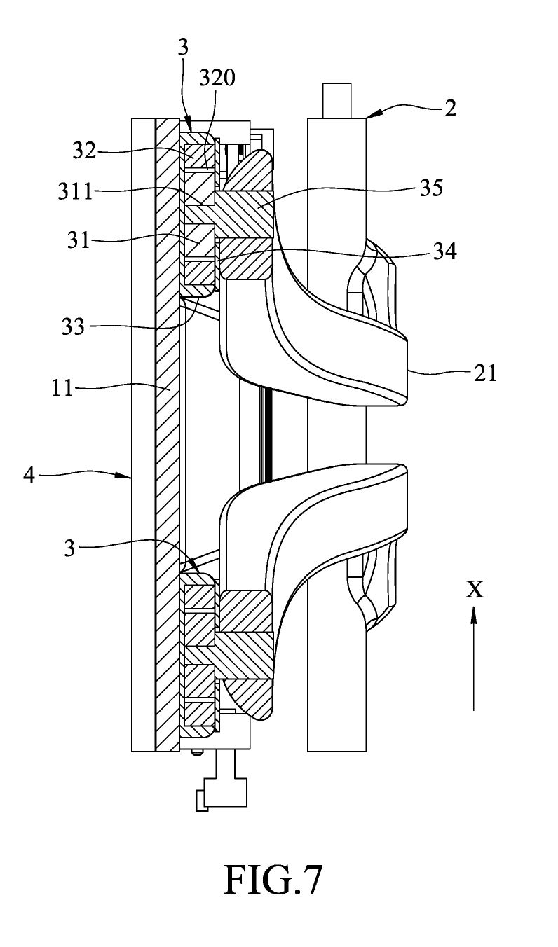

Referring to FIGS. 6 and 7, on each frame member 21, the corresponding magnetic components 31 and pins 35 are aligned in an alignment direction (X) perpendicular to the central axis (L) (see FIG. 5), and in an ordered manner. Alternatively, in other variations of this embodiment, the alignment of the magnetic components 31 and the respective pins 35 may be arranged in other suitable manners.

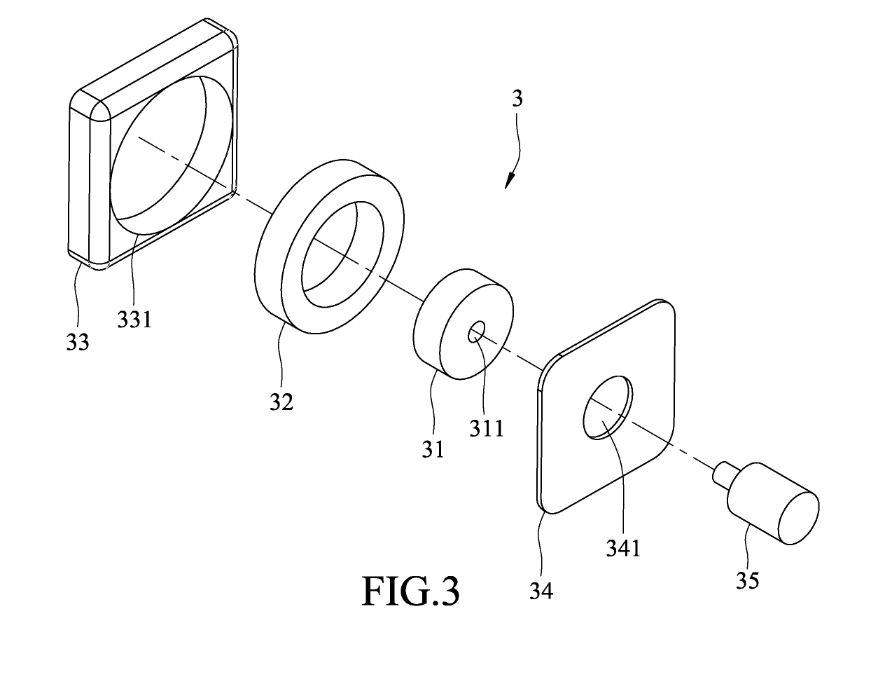

Referring back to FIG. 3, the lid hole 341 of the lid 34 has a diameter smaller than an outer diameter of the magnetic component 31 to prevent fallout of the magnetic component 31 from the retaining seat 33 therethrough. With the pin 35 movably extending through the lid hole 341, and with the presence of the gap 320 between the magnetic component 31 and the magnetic ring 32, movement of the magnetic ring 32 and the retaining seat 33 relative to the magnetic component 31 is permitted.

Referring back to FIG. 3, FIG. 6 and FIG. 7, when the support frame device of the disclosure is used to support multiple back plates 11, the connected back plates 11 are first connected fixedly and individually to the retaining seats 33 of the corresponding magnetic units 3. Since the retaining seat 33 of each of the magnetic units 3 receives fittingly the magnetic ring 32 therein, and is connected to corresponding one of the back plates 11, magnetic repulsion between the magnetic components 31 and the corresponding magnetic rings 32 of the magnetic units 3 enables the back plates 11 to move in a restrictive manner relative to the magnetic components 31 and the frame members 21 so that angles and positions of the back plates 11 can be adjusted. That is, the back plates 11 can be driven by the magnetic rings 32 to be orderly arranged, thereby ensuring proper arrangement among the back plates 11 in a simple and cost-effective manner.

While the present invention has been described in connection with what is considered the exemplary embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A support frame device adapted for supporting two back plates thereon, said support frame device comprising:
a stationary frame unit that is adapted for supporting the back plates thereon; and
a plurality of magnetic units, each of which includes
a magnetic component connected fixedly to said stationary frame unit, and
a magnetic ring adapted to be connected fixedly to a corresponding one of the back plates, surrounding said magnetic component, and being magnetically repulsed from said magnetic component,
whereby the back plates are driven by said magnetic rings of said magnetic units to be orderly arranged.

2. The support frame device as claimed in claim 1, wherein
said magnetic component of each of said magnetic units has an extension hole; and
each of said magnetic units further includes a pin that extends through said stationary frame unit and said extension hole of said magnetic component for connecting fixedly said magnetic component to said stationary frame unit.

3. The support frame device as claimed in claim 2, wherein each of said magnetic units further includes
a retaining seat that receives said magnetic component and said magnetic ring therein, that is adapted to be connected to the corresponding one of the back plates, and that has an opening opened toward said stationary frame unit; and
a lid that covers said opening of said retaining seat and that has a lid hole,
said pin extending movably through said lid hole of said lid and fittingly through said extension hole of said magnetic component so as to allow movement of said magnetic ring and said retaining seat relative to said magnetic component.

4. The support frame device as claimed in claim 1, wherein on each of said frame members, said magnetic components of the corresponding ones of said magnetic units are aligned.

5. The support frame device as claimed in claim 4, wherein said magnetic component and said magnetic ring of each of said magnetic units cooperatively define a gap therebetween.

6. The support frame device as claimed in claim 5, wherein said gap of each of said magnetic units has a width ranging between 0.5 millimeters and 1.5 millimeters.

7. The support frame device as claimed in claim 6, wherein the width of said gap of each said magnetic units is 1 millimeter.

8. The support frame device as claimed in claim 1, wherein said magnetic component and said magnetic ring of each of said magnetic units cooperatively define a gap therebetween.

9. The support frame device as claimed in claim 8, wherein said gap of each of said magnetic units has a width ranging between 0.5 millimeters and 1.5 millimeters.

10. The support frame device as claimed in claim 9, wherein the width of said gap of each said magnetic units is 1 millimeter.

11. The support frame device as claimed in claim 1, wherein opposite magnetic poles of said magnetic component and said magnetic ring of each of said magnetic units are arranged in a radial direction of said magnetic ring.

12. The support frame device as claimed in claim 1, wherein opposite magnetic poles of each of said magnetic component and said magnetic ring of each of said magnetic units are arranged in an axial direction parallel to a central axis of said magnetic ring.
